(19) United States
(12) Patent Application Publication
(10) Pub. No.: US 2013/0102998 A1
(43) Pub. Date: Apr. 25, 2013

(54) HOLDER AND A METHOD OF USING THE HOLDER

(71) Applicants: James Coghill, Nottingham (GB); Robert Armstrong, Nottingham (GB)

(72) Inventors: James Coghill, Nottingham (GB); Robert Armstrong, Nottingham (GB)

(73) Assignee: AESICA FORMULATION DEVELOPMENT LIMITED, Nottingham (GB)

(21) Appl. No.: 13/695,115

(22) PCT Filed: Apr. 28, 2011
(86) PCT No.: PCT/GB2011/000672

§ 371 Date: Jan. 9, 2013

(30) Foreign Application Priority Data
Apr. 30, 2010 (GB) 1007237.9

(51) Int. Cl. A61J 7/00

(52) U.S. Cl. CPC A61J 7/0053
USPC 604/514; 604/77

(57) ABSTRACT

A holder for a drug delivery device comprising a body portion, and a first flange extending from the holder, wherein the body portion comprises a receiving portion for receiving a drug delivery device, and the flange extends from the body portion of the holder.

### FIELD OF THE INVENTION

This invention relates to a holder and particularly, but not exclusively, to a holder for a drug delivery device which enables a user to dispense a drug in a suitable formulation into a buccal cavity of a patient, together with a method for using such a holder.

### BACKGROUND OF THE INVENTION

It is known to treat patients suffering from epilepsy (status epilepticus) with anticonvulsant drugs, such as lorazepam, a benzodiazepine drug having anticonvulsant properties. Lorazepam is administered by injection as a first line treatment for terminating acute seizures. However, lorazepam must be administered by a qualified medical person, and the patient must be monitored after the drug has been administered, in order to monitor for an adverse reaction to the treatment.

In its liquid form, lorazepam is virtually insoluble in water and therefore requires a solvent such as polyethylene glycol to maintain reasonable levels in solution.

Even when stored at temperatures of 4 to 8° C., the lorazepam solutions are unstable and have a limited shelf life.

Lorazepam may also be administered in tablet form. However, in this form, there are issues relating to the safety of the patient who may choke on the tablet. Also, the care giver may be accidentally bitten by the patient experiencing an acute seizure. Further, the efficacy of the drug in this form may be reduced if, for example, the patient swallows, or spits out the tablet before it has had time to be fully digested and absorbed.

In circumstances where the patient may be experiencing an epileptic seizure, it is likely to be necessary for a person having little or no medical training to administer an anticonvulsant drug, such as lorazepam. However, it can be very difficult for a person such as a carer to administer an anticonvulsant drug such as lorazepam. This is because if the drug is applied in its liquid form, it is usually necessary for a carer to inject the drug into the patient. If a patient is having seizures at the time that the drug is administered, this can very difficult to achieve.

Further, it is common to administer lorazepam rectally. This method of administering the drug does not preserve the dignity of the patient, however.

Therefore, there is a need for an alternative method of administering a drug, such as lorazepam, to a patient in order that it can be reliably used in emergency situations by, for example, a non-medically qualified carer.

In this respect it is known to use lorazepam in powder form in order to enable the buccal delivery, i.e. administration through the buccal mucosa, mainly composed of the lining of the cheeks. Such delivery has been shown that it may be effective, for example, in terminating acute epileptic seizures. This is because the drug is relatively easily absorbed into the body across the mucosal membranes of the buccal cavity when the drug is in its powdered form. If a drug such as lorazepam is used in powdered form and delivered via the buccal cavity, then the functional excipients in the formulation, such as mucoadhesive polymers, may rapidly hydrate, disperse and form a mucoadhesive. It is the formation of this mucoadhesive that aids absorption of the drug into the body of a patient. Further, in the treatment of acute epileptic seizures, lorazepam may be given in a very low dose, in such circumstances it must always be diluted before use, which hinders the use of lorazepam in emergency situations.

In order to deliver lorazepam buccally, it is necessary to use a suitable delivery device. Conventionally known dosage forms for buccal delivery include tablets, patches, tapes, films, semisolids and powders.

For use in emergency situations by, for example, a non-medically qualified carer, such a delivery device must necessarily be easy and safe to use.

### SUMMARY OF THE INVENTION

According to a first aspect of the present invention there is provided a holder for a drug delivery device comprising;
a body portion; and
a first flange extending from the holder,
wherein the body portion comprises a receiving portion for receiving a drug delivery device, and the flange extends from the body portion of the holder.

By means of the present invention it is possible to adapt an existing drug delivery device for use in the buccal delivery of a drug, such as lorazepam.

An existing drug delivery device may, for example, comprise a conventionally known nasal delivery device comprising a plunger, a container having a base and top and a delivery nozzle, the plunger and the container being connected to one another such that it is possible for the plunger to move relative to the container. A drug formulation may be held within the container, for example, as a blended powder. The existing drug delivery device, e.g. nasal delivery device, further comprises a chamber defining an air space.

A user of such a drug delivery device, e.g. the aforementioned nasal delivery device, may push the plunger towards the container. This results in the volume of the air space in the chamber being reduced thereby increasing the pressure within the chamber. Once an excess of pressure has been built up within the chamber, the base of the container is forced to move forward until it pushes out the top of the container. This results in a sudden movement of compressed air and a rapid decrease in the pressure which forces the formulation out of the nozzle.

One such known delivery device comprises a housing adapted to receive a container and a delivery nozzle, such that it is possible for the container to move relative to the delivery nozzle.

The delivery nozzle may be formed integrally with, or separate from, the housing. The housing may comprise a wall having defined thereon a ridge or lip. The cross-sectional dimensions of the ridge or lip are greater than the cross-sectional dimensions of the housing as a whole. The ridge/lip thus extends beyond the housing wall and may be used to locate the device in a holder according to an embodiment of the invention.

When such a drug delivery device is positioned within a drug delivery device holder according to an embodiment of the present invention, the container of the delivery device will be received within the receiving portion of the body portion of the holder.

In embodiments of the invention, the holder is dimensioned such that, at least a portion of, the container of the drug delivery device extends beyond the body portion of the holder. This means that, in use, a user may readily gain access to the container in order to push the container towards the delivery nozzle to thereby deliver the drug in a suitable formulation contained within the container of the drug delivery device.

In an embodiment of the invention, the first flange is a radially extending flange comprising a first flange portion, e.g. a left portion, and a second flange portion, e.g. a right portion, the first and second flange portions being adapted to support a first and second finger respectively of a user. Thus, the radially extending first flange extends substantially perpendicularly to the longitudinal axis of the body portion of the holder. The radially extending first flange may be circumferential to the body portion of the holder or, preferably, as depicted in the figures herein described, the first flange may extend either side of the body portion of the holder.

The holder may optionally further comprise a second flange extending from the body portion, spaced apart from the first flange and positioned towards a distal end of the holder.

The second flange may serve as a guard portion to protect the fingers of a user from possible injury through, for example accidental biting by the patient having the seizure. The second flange is also a radially extending flange which may be circumferential to the body portion of the holder or, preferably, as depicted in the figures herein described, extends either side of the body portion of the holder.

Because both the first and second flanges are positioned on, or form part of the body portion of the holder, the nozzle remains free to extend into the buccal cavity of a patient and is unhindered by the presence of the flanges.

The holder may further comprise a clip adapted to secure a drug delivery device within the holder.

The clip may be defined by a cut out portion and may be formed in the body portion of the holder.

The clip may be integrally formed with the body portion of the holder.

The body portion of the holder may be formed from any desirable material, but preferably the body portion is formed from a plastics material.

Because the clip may be formed by cutting out a portion of the body portion to define the clip, the clip may be resiliently deformable relative to the body portion.

This means that a holder according to such an embodiment of the invention is particularly suitable for use with a drug delivery device of the type hereinbefore described, e.g. comprising a ridge or lip extending outwardly from a wall of the container. When such a drug delivery device is inserted into a holder according to this embodiment of the invention, the clip may deform outwardly in order to allow the lip or ridge of the drug delivery device to be moved through the receiving portion of the body portion of the holder.

The clip may be in the form of a tab which may have a length that is less than the length of the body portion of the holder. This means that a recess may be defined in the body portion above the tab. The body portion may be shaped such that when a drug delivery device is situated within the holder, the lip or ridge of the drug delivery device will be positioned in the recess of the holder. The clip may serve to hold the drug delivery device in position and will abut with the wall of the container, with the lip or ridge extending into the recess.

The holder may comprise one or more clips formed in the body portion of the holder.

The holder may further comprise a holder nozzle extending from the body portion of the holder.

The holder nozzle may be dimensioned such that its length is greater than the length of the delivery nozzle. This enables the drug to be more easily administered via buccal delivery, since the length of the holder nozzle enables a user to ensure that a distal end of the holder nozzle makes contact with the buccal cavity of the patient to whom the drug is to be administered, before introducing the drug into the buccal cavity. This in turn means that it is possible to use, for example, an existing nasal drug delivery device, and to modify the existing nasal drug delivery device for buccal delivery.

According to a second aspect of the present invention there is provided a holder for a drug delivery device having a proximal end and a distal end and comprising a holder nozzle, and a first flange extending from the nozzle at a proximal end of the holder, e.g. a radially extending first flange as hereinbefore described.

In such an embodiment of the invention, when the holder is used with a drug delivery device having a delivery nozzle, the delivery nozzle of the drug delivery device will be contained within the holder nozzle.

A holder according to the second aspect of the present invention may further comprise one or more of the features hereinbefore described with respect to the first aspect of the invention.

According to a third aspect of the present invention there is provided a drug delivery system comprising:
a drug delivery device comprising a container and a delivery nozzle, the container being moveable relative to the delivery nozzle;
a holder comprising a body portion comprising a first flange extending from the body portion and a receiving portion for receiving the drug delivery device such that when the device is received within the body portion, the container is retained at least partially within the body portion.

By means of the present invention it is possible to modify an existing drug delivery device, for example, a drug delivery device adapted to administer drugs into the nasal cavity of a patient, such that it is rendered suitable for administering a drug into the buccal cavity of a patient.

The holder forming part of the third aspect of the invention may contain one or more of the features of the holder described herein above with respect to the first aspect of the invention. According to a fourth aspect of the present invention there is provided a drug delivery system comprising a drug delivery device comprising a container and a delivery nozzle, the container being moveable relative to the delivery nozzle; and
a holder comprising a holder nozzle having a proximal end and a distal end, and a first flange extending from the proximal end of the holder nozzle.

According to a fifth aspect of the present invention the drug delivery device and the drug delivery device holder may be provided as a single, optionally integral, device.

Thus, according to this aspect of the invention there is provided a drug delivery device comprising:
a body portion;
a nozzle extending from the body portion;
a first flange extending from the body portion; and
a plunger,
   the body portion and the nozzle having a bore extending therethrough, and the plunger being movable along the bore.

By integrally forming the first flange with the body portion, there is no need to combine a separate holder with a proprietary drug delivery device in order to dispense a drug or suitable formulation into the buccal cavity of a patient. This makes the dispensing of such a drug simpler and more convenient.

Optionally, the plunger is movable between extended and depressed conditions.

The drug delivery device is intended as a single use device with the requisite quantity of the drug for a single treatment being contained within the bore of the device.

Alternatively, the first flange extends from a proximal end of the body portion.

Alternatively, the first flange comprises first and second flange portions, e.g. left and right flange portions.

As previously mentioned, the first and second flange portions e.g. left and right flange portions, are intended to accommodate the first and second respective fingers of a user when the device is being operated.

Optionally, the device further comprises a second flange extending from the body portion, spaced apart from the first flange and positioned towards a distal end of the body portion.

As detailed above, the second flange provides protection to the fingers of the user from possible bite injury caused by the patient having a seizure.

According to a further aspect of the present invention there is provided a kit comprising;
a drug delivery device comprising a container and a delivery nozzle as hereinbefore described, e.g. a nasal drug delivery device; and
a drug delivery device holder as hereinbefore described.

According to a yet further aspect of the present invention there is provided a method of dispensing a drug from a drug delivery device into the buccal cavity of a patient using a holder comprising;
a body portion; and
a first flange extending from the holder, wherein the body portion comprises a receiving portion for receiving a drug delivery device, and the flange extends from the body portion of the holder, the method comprising the steps of
inserting the drug delivery device into the holder;
positioning the holder in a hand of a user with each of two fingers being positioned on the first flange and a thumb being positioned on the drug delivery device;
inserting the holder nozzle into the buccal cavity of the patient; and
depressing the drug delivery device relative to the holder to dispense the drug into the buccal cavity of the patient.

The method according to this aspect of the present invention may use a holder according to the first aspect of the present invention, which holder may have one or more of the features described hereinabove with respect to the first aspect of the invention.

Optionally, the body portion further comprises a clip, and the drug delivery device further comprises a lip, and the step of inserting the drug delivery device into the holder comprises the step of inserting the drug delivery device into the holder such that the lip is secured by the clip, thereby retaining the drug delivery device in the holder.

Retaining the drug delivery device within the holder simplifies the task of dispensing a drug from the delivery device into the buccal cavity of a patient who may be having a seizure.

According to a further aspect of the present invention there is provided a method of dispensing a drug from a drug delivery device into a buccal cavity of a patient using a holder comprising a holder nozzle having a proximal end and a distal end, and a first flange extending from the proximal end of the holder nozzle, the method comprising the steps of inserting the drug delivery device into the holder;
positioning the holder in a hand of a user with each of two fingers being positioned on the first flange and a thumb being positioned on the drug delivery device;
inserting the holder nozzle into the buccal cavity of the patient; and
depressing the drug delivery device relative to the holder to dispense the drug into the buccal cavity of a patient.

The method according to this aspect of the present invention may use a holder according to the second aspect of the present invention, which holder may have one or more of the features described hereinabove with respect to the second aspect of the invention.

According to a further aspect of the present invention there is provided a method of dispensing a drug from a drug delivery device into the buccal cavity of a patient, the device comprising;
a body portion;
a nozzle extending from the body portion,
a first flange extending from the body portion; and
a plunger,
   the body portion and the nozzle having a bore extending therethrough, and the plunger being movable along the bore, the method comprising the steps of:
positioning the device in a hand of a user with each of two fingers being positioned on the first flange and a thumb being positioned on the plunger;
inserting the nozzle into the buccal cavity of the patient; and depressing the plunger relative to the body portion to dispense the drug into the buccal cavity of the patient.

It will be understood by the person skilled in the art that the holder, delivery system or method as hereinbefore described, may suitably be used in association with a variety of drugs that are suitable for buccal delivery.

Such drugs shall include, without limitation, drugs which act on the peripheral nerves, adrenergic receptors, cholinergic receptors, the skeletal muscles, the cardiovascular system, smooth muscles, the blood circulatory system, synoptic sites, neuroeffector junctional sites, endocrine and hormone systems, the immunological system, the reproductive system, the skeletal system, autacoid systems, the alimentary and excretory systems, the histamine system and the central nervous system. Suitable drugs may be selected from, for example, proteins, enzymes, hormones, polynucleotides, nucleoproteins, polysaccharides, glycoproteins, lipoproteins, polypeptides, steroids, hypnotics and sedatives, psychic energizers, tranquilizers, anticonvulsants, muscle relaxants, antiparkinson agents, analgesics, anti-inflammatories, local anaesthetics, muscle contractants, antimicrobials, antimalarials, hormonal agents including contraceptives, sympathomimetics, polypeptides and proteins capable of eliciting physiological effects, diuretics, lipid regulating agents, antiandrogenic agents, antiparasitics, neoplastics, antineoplastics, hypoglycemics, nutritional agents and supplements, growth supplements, fats, ophthalmics, antienteritis agents, electrolytes and diagnostic agents.

Examples of drugs or agents useful in this invention include prochlorperazine edisylate, ferrous sulphate, aminocaproic acid, mecaxylamine hydrochloride, procainamide hydrochloride, amphetamine sulphate, methamphetamine hydrochloride, benzphetamine hydrochloride, isoproteronol sulphate, phenmetrazine hydrochloride, bethanechol chloride, methacholine chloride, pilocarpine hydrochloride, atropine sulphate, scopolamine bromide, isopropamide iodide, tridihexethyl chloride, phenformin hydrochloride, methylphenidate hydrochloride, theophylline cholinate, cephalexin hydrochloride, diphenidol, meclizine hydrochloride, prochlorperazine maleate, phenoxybenzamine, thiethylperazine maleate, anisindione, diphenadione, erythrityl tetranitrate, digoxin, isoflurophate, acetazolamide, methazolamide, bendroflumethiazide, chlorpropamide, tolazamide, chlormadinone acetate, phenaglycodol, allopurinol, aluminium aspirin, methotrexate, acetyl sulphisoxazole, hydrocortisone, hydrocorticosterone acetate, cortisone acetate, dexamethasone and its derivatives such as betamethasone, triamcinolone, methyltestosterone, 17-.beta.-estradiol, ethinyl estradiol, ethinyl estradiol 3-methyl ether, prednisolone, 17-.beta.-hydroxyprogesterone acetate, 19-nor-progesterone, norgestrel, norethindrone, norethisterone, norethiederone, progesterone, norgesterone, norethynodrel, indomethacin, naproxen, fenoprofen, sulindac, indoprofen, nitro-glycerine, isosorbide dinitrate, propranolol, timolol, atenolol, alprenolol, cimetidine, clonidine, imipramine, levodopa, chlorpromazine, methyldopa, dihydroxyphenylalanine, theophylline, calcium gluconate, ketoprofen, ibuprofen, cephalexin, erythromycin, haloperidol, zomepirac, ferrous lactate, vincamine, phenoxybenzamine, diltiazem, milrinone, captropril, mandol, quanbenz, hydrochlorothiazide, ranitidine, flurbiprofen, fenbufen, fluprofen, tolmetin, alclofenac, mefenamic, flufenamic, difuninal, nimodipine, nitrendipine, nisoldipine, nicardipine, felodipine, lidoflazine, tiapamil, gallopamil, amlodipine, mioflazine, lisinopril, enalapril, captopril, ramipril, enalaprilat, famotidine, nizatidine, sucralfate, etintidine, tetratolol, minoxidil, chlordiazepoxide, alprazolam, bretazenil, bromazepam, brotizolam, chlordiazepoxide, cinolazepam, clonazepam, cloxazolam, clorazepate, delorazepam, diazepam, estazolam, etizolam, flunitrazepam, flurazepam, flutoprazepam, halazepam, ketazolam, loprazolam, lorazepam, lonnetazepam, medazepam, midazolam, nimetazepam, nitrazepam, nordazepam, oxazepam, phenazepam, pinazepam, prazepam, premazepam, quazepam, temazepam, tetrazepam, triazolam, amitriptylin, and imipramine. Further examples are proteins and peptides which include, but are not limited to, insulin, colchicine, glucagon, thyroid stimulating hormone, parathyroid and pituitary hormones, calcitonin, renin, prolactin, corticotrophin, thyrotropic hormone, follicle stimulating hormone, chorionic gonadotropin, gonadotropin releasing hormone, bovine somatotropin, porcine somatropin, oxytocin, vasopressin, prolactin, somatostatin, lypressin, pancreozymin, luteinizing hormone, LHRH, interferons, interleukins, growth hormones such as human growth hormone, bovine growth hormone and porcine growth hormone, fertility inhibitors such as the prostaglandins, fertility promoters, growth factors, human pancreas hormone releasing factor, antiproliferative/antimitotic agents including natural products such as vinca alkaloids (i.e. vinblastine, vincristine, and vinorelbine), paclitaxel, epidipodophyllotoxins (i.e. etoposide, teniposide), antibiotics (dactinomycin (actinomycin D) daunorubicin, doxorubicin and idarubicin), anthracyclines, mitoxantrone, bleomycins, plicamycin (mithramycin) and mitomycin, enzymes (L-asparaginase which systemically metabolizes L-asparagine and deprives cells which do not have the capacity to synthesize their own asparagine); antiplatelet agents such as G(GP)II_{b}IIIₐ inhibitors and vitronectin receptor antagonists; antiproliferative/antimitotic alkylating agents such as nitrogen mustards (mechlorethamine, cyclophosphamide and analogues, melphalan, chlorambucil), ethylenimines and methylmelamines (hexamethylmelamine and thiotepa), alkyl sulfonates-busulfan, nitrosoureas (carmustine (BCNU) and analogues, streptozocin), trazenes-dacarbazinine (DTIC); antiproliferative/antimitotic antimetabolites such as folic acid analogues (methotrexate), pyrimidine analogues (fluorouracil, floxuridine, and cytarabine), purine analogues and related inhibitors (mercapto purine, thioguanine, pentostatin and 2-chlorodeoxyadenosine {cladribine}); platinum coordination complexes (cisplatin, carboplatin), procarbazine, hydroxyurea, mitotane, aminoglutethimide; hormones (i.e. oestrogen); anticoagulants (heparin, synthetic heparin salts and other inhibitors of thrombin); fibrinolytic agents (such as tissue plasminogen activator, streptokinase and urokinase), aspirin, dipyridamole, ticlopidine, clopidogrel, abciximab; antimigratory; antisecretory (breveldin); anti-inflammatory: such as adrenocortical steroids (cortisol, cortisone, fludrocortisone, prednisone, prednisolone, 6[alpha]-methylprednisolone, triamcinolone, betamethasone, and dexamethasone), non-steroidal agents (salicylic acid derivatives i.e. aspirin; para-aminophenol derivatives i.e. acetaminophen; indole and indene acetic acids (indomethacin, sulindac, and etodalac), heteroaryl acetic acids (tolmetin, diclofenac, and ketorolac), arylpropionic acids (ibuprofen and derivatives), anthranilic acids (mefenamic acid, and meclofenamic acid), enolic acids (piroxicam, tenoxicam, phenylbutazone, and oxyphenthatrazone), nabumetone, gold compounds (auranofin, aurothioglucose, gold sodium thiomalate); immunosuppressives: (cyclosporine, tacrolimus, sirolimus (rapamycin), azathioprine, mycophenolate mofetil); angiogenic agents: vascular endothelial growth factor (VEGF), fibroblast growth factor (FGF) platelet derived growth factor (PDGF), erythropoetin; angiotensin receptor blocker; nitric oxide donors; anti-sense oligionucleotides and combinations thereof; cell cycle inhibitors, mTOR inhibitors, growth factor signal transduction kinase inhibitors, chemical compound, biological molecule, nucleic acids such as DNA and RNA, amino acids, peptide, protein or combinations thereof.

It is to be understood that more than one drug or agent may be combined or mixed together and incorporated into or used by the present invention.

Other suitable drugs include but are not limited to other drugs that could be administered via buccal or sub-lingual routes such as anti-malarial drugs, galantamine, neostigmine, physostigmine, edrophoniumlevobupivacaine, lidocaine, prilocaine, mepivacaine, propofol, rapacuronium bromide, ropivacaine, tubocurarine, atracurium, doxaurium, mivacurium, pancuronium, vercuronium, pipecuronium, rocurronium amantadine, ipratropium, oxitropium, dicycloverineacetazolamide, carbamazepine, divalproex, ethosuximide, lamotrignine acid, levetriacetam, oxcarbazepine, Phenobarbital, phenyloin, pregabalin, primidone, remacemide, trimethadione, topiramate, vigabatrin, zonisamideamisulpride, aripiprazole bifemelane, bromperidol, clozapine, chlorpromazine, haloperidol, iloperidone loperidone, olanzapine, quetiapine, fluphenazine, esperidone, thiothixene, thioridazine, sulpride, ziprasidone amitryptiline, atracurium, buspirone, chlorzoxazone, clorazepate, cisatracurium, cyclobenzaprine, eperisone, esopiclone, hydroxyzine, mirtazapine, mivacurium, pagoclone, superide, zaleplon, zopicloneentacapone, lazebemide, selegiline, tolcaponeglatiramer, estradiol, proqesteronememanine, nimodipine, riluzole, rivastigmine, tacrine, xaliprodencarbidopa, levodopa, tacrine, donezepil, rivastigmine, galantamiacetylcholine, serotonin, 5-hydroxytryptamine (5-HT), GABA, glutamate, aspartate, glycine, histamine, epinephrine, norpinephrine, dopamine, adenosine, ATP nitric oxidealmotriptan, aniracetam, atomoxetine, benserazide, bromocriptine, bupropion, cabergoline, citalopram, clomipramine, desipramine, dihydroergotmine, doxepin duloxetine, eletriptan, escitalopram, fluvoxamine, gabapentin, imipramine, moclobemide, naratriptan, nefazodone, nefiracetam acamprosate, nicergoline, buprenorphine, naloxone, apomorphine.

A preferred class of drugs is the anticonvulsants, e.g. for the treatment or alleviation of epilepsy (status epilepticus), such as the benzodiazepines. Examples, of benzodiazepines include, alprazolam, chlordiazepoxide, clonazepam, clorazepate, diazepam, estazolam, flurazepam, halazepam, lorazepam, midazolam, nitrazepam, oxazepam, prazepam, quazepam, temazapem, bromazepam, flunitrazepam, triazolam, bentazepam, brotizolam, clotiazepam, delorazepam, ethyl loflazepate, etizolam, fludiazepam, ketozolam, loprazolam, lormetazepam, nordazepam, mexazolam, nimetazepam, pinazepam and tetrazepam. An especially preferred benzodiazepine is lorazepam (7-chloro-5-(2-chlorophenyl)-1 , 3-dihydro-3-hydroxy-2H-1 , 4-benzodiazepin-2-one).

There now follows a description of an embodiment of the invention, by way of non-limiting example, with reference being made to the accompanying drawings in which:

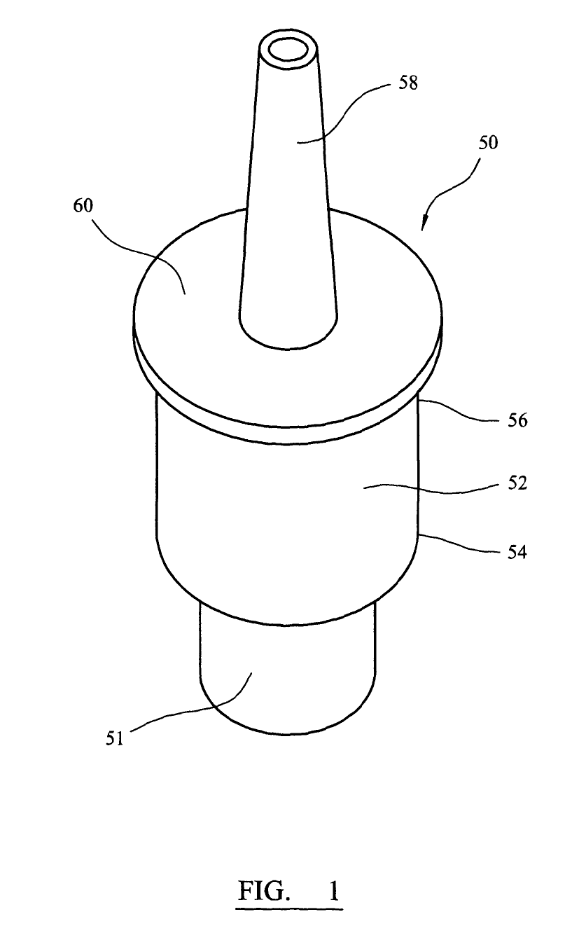

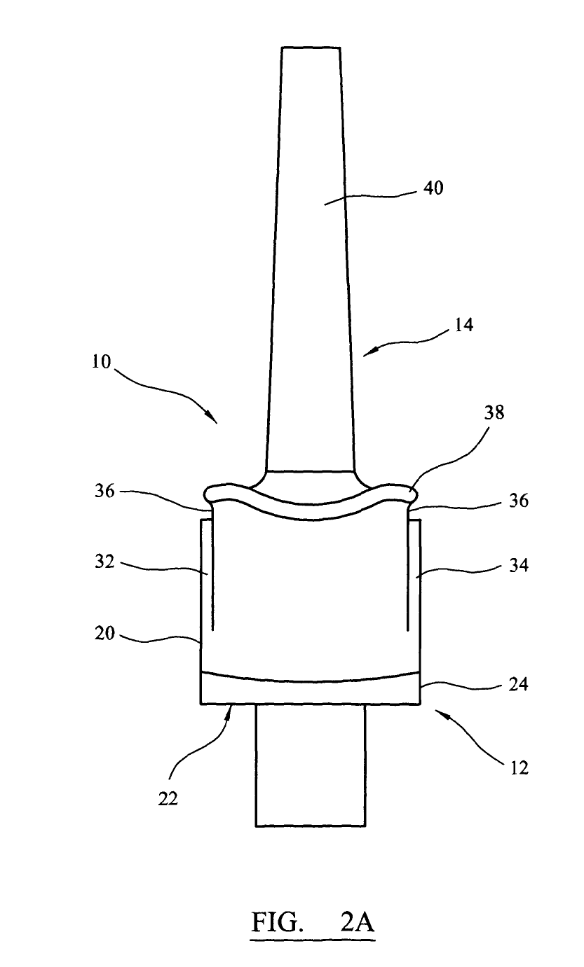

FIG. 1 shows a perspective view of a drug delivery device forming part of a drug delivery system according to the invention;

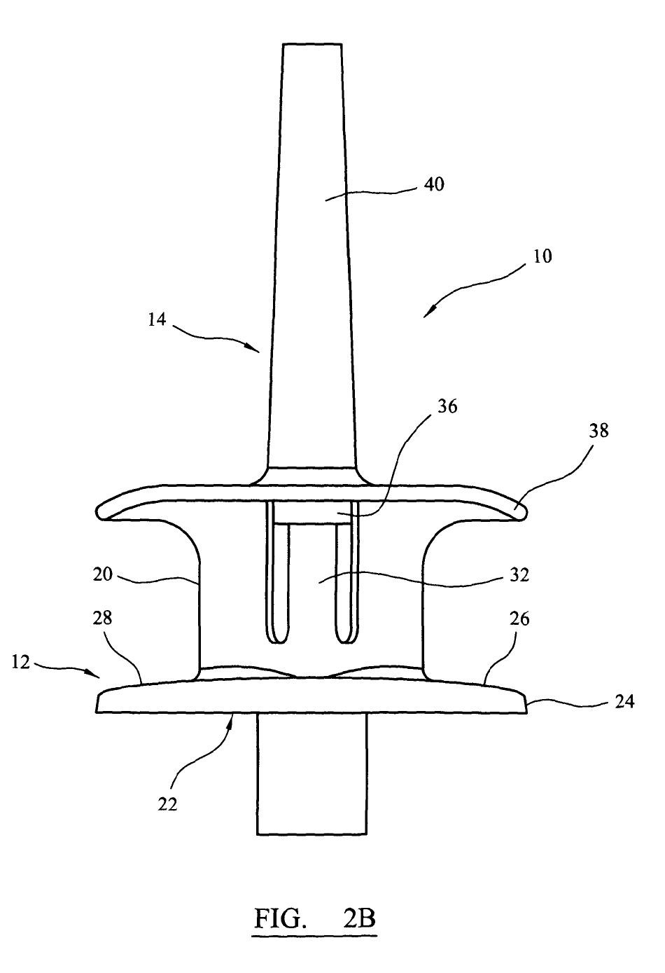

FIG. 2A shows a side elevational view of a holder according to an embodiment of the first aspect of the invention, and forming part of a drug delivery system according to the third aspect of the invention;

FIG. 2B shows a front elevational view of the. holder of FIG. 2A;

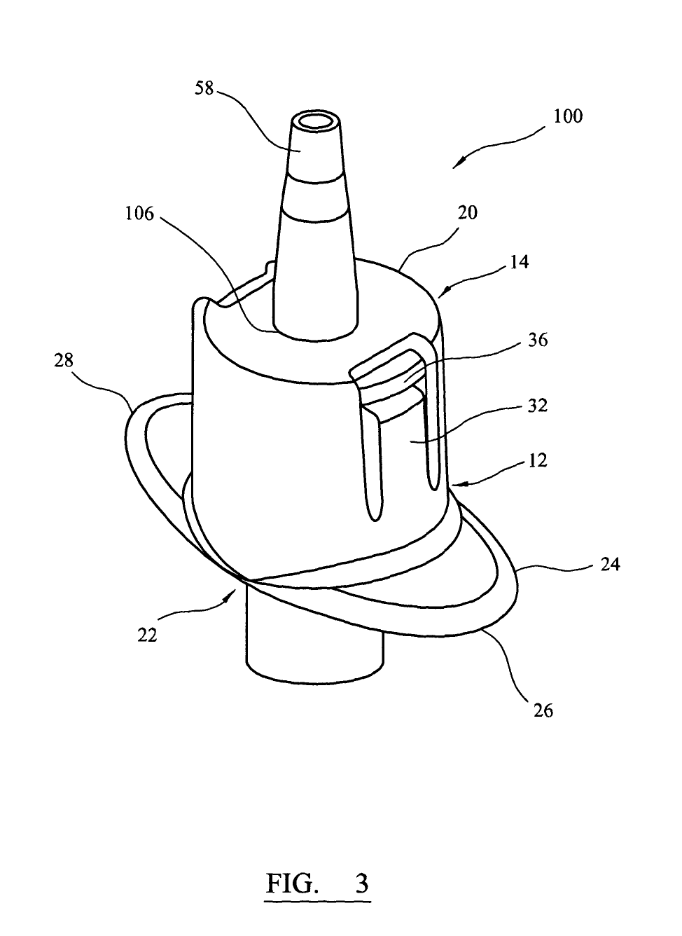

FIG. 3 shows a perspective view of a holder according to a second embodiment of the first aspect of the invention, and forming part of a drug delivery system according to the invention;

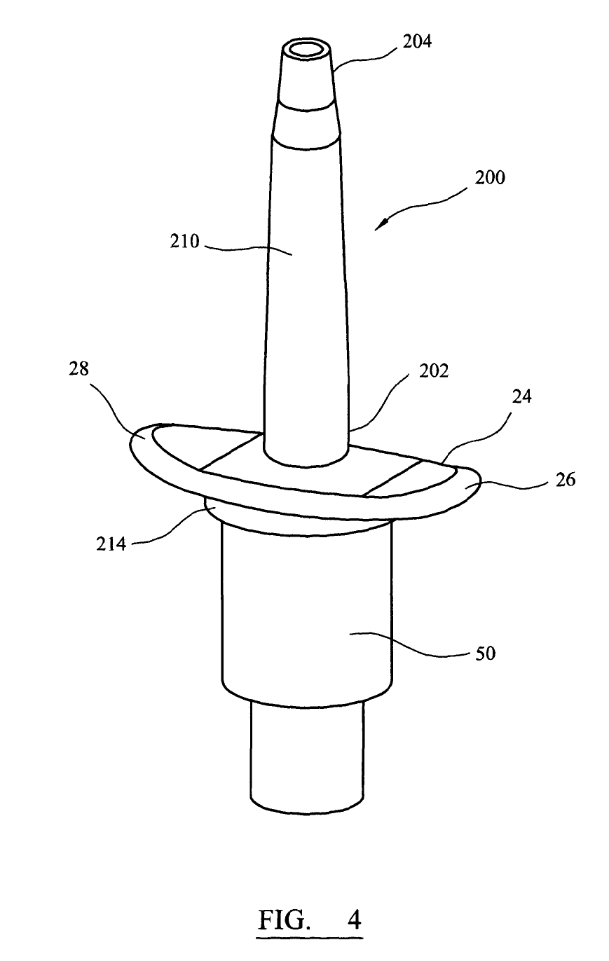

FIG. 4 shows a perspective view of a holder according to an embodiment of the second aspect of the invention, and forming part of a drug delivery system according to the invention; and

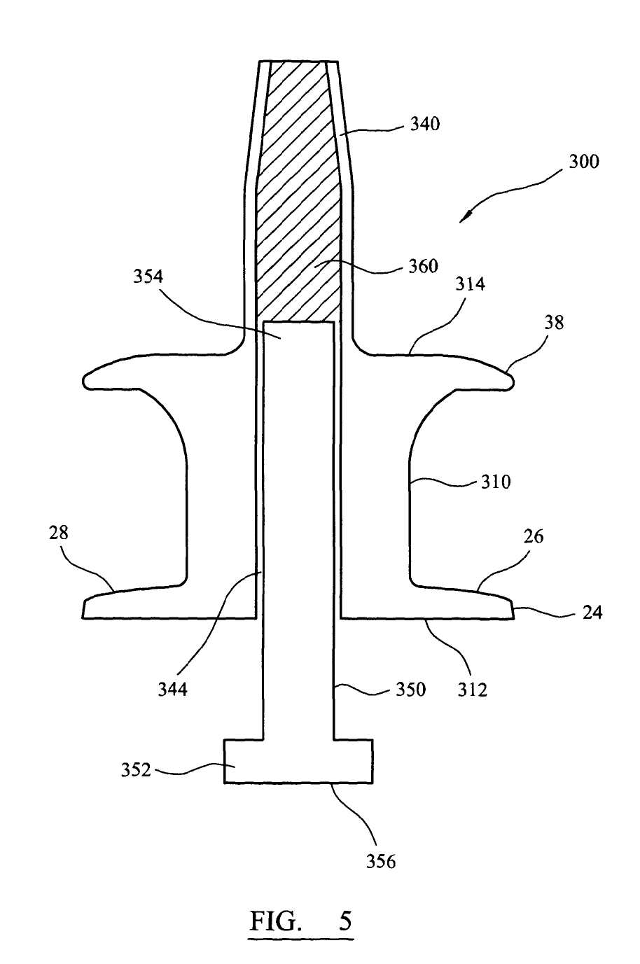

FIG. 5 shows a cross-sectional view of a drug delivery device according to an embodiment of the fifth aspect of the invention.

Referring to FIGS. 1, 2A and 2B, a holder according to a first embodiment of the invention is designated generally by the reference numeral 10, the holder 10 having a proximal end 12 and a distal end 14. The holder 10 comprises a body portion 20 and a holder nozzle 40 extending from the body portion 20.

In this embodiment, the holder nozzle 40 extends substantially axially from the body portion 20 such that the holder nozzle 40 is positioned at the distal end 14 of the holder 10. In other embodiments of the invention, the holder nozzle 40 may extend at an angle to the body portion 20 of the holder 10.

The body portion 20 further comprises a receiving portion 22 adapted to receive a dispensing drug delivery device 50.

As shown in FIG. 1, the delivery device 50 comprises a plunger 51, a container 52 having a proximal end 54 and a distal end 56:, a delivery nozzle 58 extending from the distal end 56 of the container 52, and a lip 60 located at the distal end 56 of the container 52.

The delivery nozzle 58 is accommodated within the holder nozzle 40.

The body portion 20 further comprises a first flange 24 which extends substantially laterally from the body portion 20.

In this embodiment the first flange 24 comprises first and second flange portions 26,28 shaped such that a finger of a user may rest on each flange portion 26,28.

Typically, a user of the holder will place his first and second fingers on the first and second flange portions 26, 28 respectively.

The body portion 20 further comprises first and second tabs 32, 34 cut out of the body portion 20.

The body portion 20 may be formed from any convenient material but is preferably formed from a plastics material. Because each tab 32, 34 has been formed by cutting out a portion of the body portion 20, each tab 32, 34 is resiliently deformable and thus acts as a clip or a spring.

Each tab 32, 34 does not extend for the entire axial length of the body portion 20, and thus defines a recess 36. When a drug delivery device 50 of the type described hereinabove and illustrated in FIG. 1, is inserted into the holder 10, the lip 60 of the drug delivery device 50 causes the tab 32,34 to deform outwardly as the delivery device 50 is inserted into the holder 10. Once the delivery device 50 has been properly inserted such that the delivery nozzle 58 is within the holder nozzle 40, the lip 60 of the delivery device 50 will be positioned above the tab 32, 34 thus allowing the tab 32, 34 to spring back into its original position where it will rest against the container portion 52 of the delivery device 50 and abut against a surface of the lip 60 thus holding the delivery device 50 in position within the holder 10.

In the embodiment shown in FIG. 2, the body portion 20 also includes a second flange 38 extending substantially laterally from the body portion 20 and spaced apart from the first flange 24. The second flange 38 acts as a guard to protect the hand of a user from, for example, accidental biting by the patient.

In use, the dispensing drug delivery device 50; is inserted into the body portion 20 of the holder 10 such that the delivery nozzle 58 of the delivery device 50 is accommodated within the holder nozzle 40.

Each resilient tab 32, 34 locates against an edge of the delivery device 50 so as to secure the delivery device 50 in the holder 10.

The holder 10 and attached drug delivery device 50 are then positioned in the hand of a user with each of two fingers being positioned on a respective one of the first and second flange portions 26, 28 and a thumb being positioned on the delivery device 50.

The holder nozzle 40 can then be inserted into the buccal cavity of the patient.

The user then depresses the delivery device 50 relative to the holder 10 in order to dispense the drug into the buccal cavity of the patient.

In the embodiment shown, it is the plunger 51 of the delivery device 50 which is depressed by the user when the drug is dispensed.

Referring to FIG. 3, a holder according to a second embodiment of the invention is designated generally by the reference numeral 100. Features of the holder 100 which correspond to those of holder 10 have been given corresponding reference numerals for ease of reference.

The holder 100 has a proximal end 12 and a distal end 14 and comprises a body portion 20 having a receiving portion 22 which is adapted to receive the dispensing drug delivery device 50.

The body portion 20 further comprises a first flange 24 which extends substantially laterally from the body portion 20 at the proximal end of the holder 100. In this embodiment, the first flange 24 comprises first and second flange portions 26, 28 as described above with respect to the first aspect of the invention.

In addition, the body portion further comprises tabs 32, 34 which have been cut out of the body portion 20. The tabs 32, 34 serve to locate the delivery device 50 in the holder 100 in the same manner as that described above in respect of the first embodiment of the invention.

The distal end 14 of the holder 100 comprises an aperture 106 which is adapted to accommodate a delivery nozzle 58 of the delivery device 50.

In use, the dispensing drug delivery device 50 is inserted into the body portion 20 of the holder 100 such that the delivery nozzle 54 extends through the aperture 106.

The tabs 32, 34 serve to secure the delivery, device 50 in the holder 100 in the same manner as that described above in respect of the first aspect of the invention.

Referring to FIG. 4, a holder according to a second embodiment of the invention is designated generally by the reference numeral 200. Features of the holder 200 which correspond to those of holder 10 have been given corresponding reference numerals for ease of reference.

The holder 200 comprises a holder nozzle 210 having a proximal end 212 and a distal end 214, and a first flange 24 extending from the proximal end 212 of the holder nozzle 210.

The first flange 24 comprises first and second flange portions 26, 28 as previously described in relation to the first and second embodiments of the invention.

In use, the delivery nozzle 58 of the dispensing drug delivery device 50 is inserted into 15 the holder nozzle 210 of the holder 200, such that the proximal end 212 of the holder nozzle 210, and the first flange 24, abut against the distal end 56 of the container portion 52 of the delivery device 50.

The combined holder 200 and delivery device 50 can then be operated in the same manner as described above in respect of the first aspect of the invention.

Referring to FIG. 4, a holder according to an embodiment of the second aspect of the invention is designated generally by the reference numeral 200. Features of the holder 200 which correspond to those of holder 10 have been given corresponding reference numerals for ease of reference.

The holder 200 has a proximal end 202 and a distal end 204 and comprises a holder nozzle 210 and a first flange 24 extending substantially laterally from the holder nozzle 210 at a proximal end 212 of the holder 200.

In the embodiment shown in FIG. 4, the first flange comprises first and second flange portions 26, 28 as described above with respect to the first aspect of the invention.

The distal end 202 of the holder 200 comprises an aperture 214 which is adapted to accommodate a delivery nozzle 58 of the delivery device 50.

In use, the holder 200 is placed over the dispensing drug delivery device 50 such that the delivery nozzle 58 of the delivery device 50 is contained within the holder nozzle 210.

The holder 200 and delivery device 50 may then be operated in the same manner as described above with respect to the first embodiment of the invention.

Referring to FIG. 5, a drug delivery device according to an embodiment of the fifth aspect of the invention is designated generally by the reference numeral 300. Features of the holder 300 which correspond to those of holder 10 have been given corresponding reference numerals for ease of reference.

The delivery device 300 comprises a body portion 310 having a proximal end 312 and a distal end 314, and a nozzle 340 extending from the distal end 314 of the body portion 310.

The body portion 310 further comprises a first flange 24 extending substantially laterally from the body portion 310, further comprising first and second flange portions 26,28 as previously described in reference to the first aspect of the invention.

In the embodiment shown in FIG. 5, the drug delivery device 300 further comprises a second flange 38 extending from the body portion 310 and extending

The body portion 310 and the nozzle 340 have a bore 344 extending therethrough and into which is received a plunger 350.

The plunger 350 is movable along the. Bore 344 between a first position in which the plunger 350 is fully extended from the body portion 310, and a second position in which the plunger 350 is fully depressed into the body portion 310.

When the plunger 350 is fully extended from the body portion 310, the bore defines a dispensing volume 360 which contains the drug to be dispensed.

In the embodiment shown, the plunger 350 has a proximal end 352 and a distal end 354 with a flange 356 located at the proximal end 352. The flange 356 is sized to receive the thumb of a user when the delivery device 300 is being operated.

In use, the drug delivery device 300 is then positioned in the hand of a user with each of two fingers being positioned on a respective one of the first and second flange portions 26, 28 and a thumb being positioned on the flange 356 of the plunger 350.

The nozzle 340 can then be inserted into the buccal cavity of the patient.

The user then depresses the plunger 350 relative to the body portion 310 in order to dispense the drug blended in a suitable formulation into the buccal cavity of the patient.

While the invention has been described in relation to a particular drug delivery, it is to be understood that the invention may equally be applied to alternative drug delivery devices having differing configurations and/or methods of operation. Examples of alternative drug delivery devices include, but are not limited to: powder stick packs; spring loaded tablet dispensers; gel dispensers; syringes. These delivery devices may be modified to fit a holder according to the present invention either at the point of manufacture or by use of a suitable adapter, for example.

1. A holder for a drug delivery device comprising;
a body portion; and
a first flange extending from the holder,
wherein the body portion comprises a receiving portion for receiving a drug delivery device, and the flange extends from the body portion of the holder.

2. A holder according to claim 1 wherein the first flange comprises first and second flange portions.

3. A holder according to claim 1 further comprising a second flange extending from the body portion, spaced apart from the first flange and positioned towards a distal end of the holder.

4. A holder according to claim 1 further comprising a clip adapted to secure a drug delivery device within the holder.

5. A holder according to claim 4 wherein the clip comprises a cut out portion formed in the body portion.

6. A holder according to claim 4 wherein the clip is integrally formed with the body portion.

7. A holder according to claim 4 wherein the clip defines a recess in the body portion.

8. A holder according to claim 1 further comprising a holder nozzle extending from the body portion.

9. A holder for a drug delivery device having a proximal end and a distal end and comprising a holder nozzle, and a first flange extending from the holder nozzle at a proximal end of the holder, said holder for a drug delivery device comprising:
a body portion; and
a first flange extending from the holder,
wherein the body portion comprises a receiving portion for receiving a drug delivery device. and the flange extends from the body portion of the holder.

10. A holder according to claim 9 wherein the first flange comprises first and second flange portions.

11. A drug delivery system comprising:
a drug delivery device comprising a container and a delivery nozzle, the container being moveable relative to the delivery nozzle and comprising a lip;
a holder for a drug delivery device comprising:
a body portion: and
a first flange extending from the holder,
wherein the body portion comprises a receiving portion for receiving a drug delivery device, and the flange extends from the body portion of the holder.

12. A drug delivery system according to claims 11, wherein the drug is an anticonvulsant.

13. (canceled)

14. A drug delivery system according to claim 11 wherein the plunger is movable between extended and depressed conditions.

15. A drug delivery system according to claim 11 wherein the first flange extends from a proximal end of the body portion.

16. A drug delivery system according to claim 11, wherein the first flange comprises first and second flange portions.

17. A drug delivery system according to claim 11, further comprising a second flange extending from the body portion, spaced apart from the first flange and positioned towards a distal end of the body portion.

18. A drug delivery system according to claim 11, wherein the drug is an anticonvulsant.

19-20. (canceled)

21. A method of dispensing a drug from a drug delivery device into the buccal cavity of a patient using a holder comprising;
a body portion; and
a first flange extending from the holder,
wherein the body portion comprises a receiving portion for receiving a drug delivery device, and the flange extends from the body portion of the holder, the method comprising the steps of:
inserting the drug delivery device into the holder;
positioning the holder in a hand of a user with each of two fingers being positioned on the first flange and a thumb being positioned on the drug delivery device;
inserting the holder nozzle into the buccal cavity of the patient; and
depressing the drug delivery device relative to the holder to dispense the drug into the buccal cavity of the patient.

22. A method according to claim 18, the body portion further comprising a clip, and the drug delivery device further comprising a lip, and wherein the step of inserting the drug delivery device into the holder comprises the step of inserting the drug delivery device into the holder such that the lip is secured by the clip, thereby retaining the drug delivery device in the holder.

23-24. (canceled)

25. A method according to claim 18 wherein the drug is an anticonvulsant.

26-28. (canceled)
